(19) United States
(12) Patent Application Publication
(10) Pub. No.: US 2026/0256199 A1
(43) Pub. Date: Sep. 3, 2026

(54) AEROSOL PROVISION DEVICE

(71) Applicant: Nicoventures Trading Limited, London (GB)

(72) Inventors: Yudong ZHANG, Shenzhen (CN); Deng DAI, Shenzhen (CN)

(21) Appl. No.: 19/494,691

(22) PCT Filed: Jun. 19, 2024
(86) PCT No.: PCT/EP2024/067115

§ 371 Date: Dec. 18, 2025

(30) Foreign Application Priority Data
Jun. 19, 2023 (CN) 2023107303663
Sep. 12, 2023 (GB) 2313908.2

(51) Int. Cl. A24F 40/42; H05B 6/10

(52) U.S. Cl. CPC A24F 40/42; H05B 6/105

(57) ABSTRACT

An aerosol provision device for generating aerosol from an aerosol generating material is provided. The aerosol provision device comprises a body defining an opening; a heating zone arranged to receive at least a portion of an article comprising aerosol generating material inserted through the opening; and a cover mechanism. The cover mechanism comprises a cover member arranged to selectively at least partially cover the opening and an actuating member arranged to rotate on the body to actuate the cover member. Rotation of the actuating member relative to the body causes the cover member to move between a relatively open position in which the at least a portion of an article is able to pass through the opening and a relatively closed position in which the at least a portion of an article is prevented from being able to pass through the opening. The cover mechanism comprises a magnetic biasing arrangement configured to bias the cover member towards at least one of the relatively open position and the relatively closed position.

### CROSS-REFERENCE TO RELATED APPLICATIONS

This present application is a National Phase entry of PCT Application No. PCT/EP2024/067115, filed Jun. 19, 2024, which claims priority from Chinese Application No. 2023107303663, filed Jun. 19, 2023, and also from Great Britain Application No. 2313908.2, filed Sep. 12, 2023, all of which are fully incorporated herein by reference in their entireties.

### TECHNICAL FIELD

The present invention relates to an aerosol provision device for generating an aerosol from aerosol-generating material. The present invention also relates to an aerosol provision system.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

In accordance with embodiments described herein, there is provided an aerosol provision device for generating aerosol from an aerosol generating material, the aerosol provision device comprising: a body defining an opening; a heating zone arranged to receive at least a portion of an article comprising aerosol generating material inserted through the opening; and a cover mechanism comprising: a cover member arranged to selectively at least partially cover the opening; an actuating member arranged to rotate on the body to actuate the cover member; wherein rotation of the actuating member relative to the body causes the cover member to move between a relatively open position in which the at least a portion of an article is able to pass through the opening and a relatively closed position in which the at least a portion of an article is prevented from being able to pass through the opening; and a magnetic biasing arrangement configured to bias the cover member towards at least one of the relatively open position and the relatively closed position.

In an embodiment of any of the above, the magnetic biasing arrangement is configured to bias the cover member away from an intermediate position between the relatively open position and the relatively closed position.

In an embodiment of any of the above, the intermediate position is half way between the relatively open position and the relatively closed position.

In an embodiment of any of the above, the magnetic biasing arrangement is configured to bias the cover member towards the relatively open position over a first range of motion adjacent to the relatively open position.

In an embodiment of any of the above, the magnetic biasing arrangement is configured to bias the cover member towards the relatively closed position over a second range of motion adjacent to the relatively closed position.

In an embodiment of any of the above, the magnetic biasing arrangement is configured to bias the cover member towards the relatively open position.

In an embodiment of any of the above, the magnetic biasing arrangement is configured to bias the cover member towards the relatively closed position.

In an embodiment of any of the above, the magnetic biasing arrangement is configured to bias the cover member from the relatively open position to a fully closed position.

In an embodiment of any of the above, the magnetic biasing arrangement is configured to bias the cover member towards the relatively closed position to a fully open position.

In an embodiment of any of the above, the magnetic biasing arrangement comprises a first magnetic configuration and a second magnetic configuration, wherein the first magnetic configuration and the second magnetic configuration are arranged to interact to bias rotation of the actuating member relative to the body.

In an embodiment of any of the above, rotation of the actuating member causes relative movement between the first and second magnetic configurations.

In an embodiment of any of the above, the first magnetic configuration is in a fixed relationship with the actuating member and the second magnetic configuration is in a fixed relationship with the body.

In an embodiment of any of the above, the first magnetic configuration comprises a first magnetic element and the second magnetic configuration comprises a second magnetic element, wherein the first magnetic element is orientated to have an opposing magnetic polarity to the second magnetic element such that the first and second magnetic elements attract each other.

In an embodiment of any of the above, the first magnetic element is arranged proximal to the second magnetic element when the cover member is in at least one of one of the relatively open position and the relatively closed position.

In an embodiment of any of the above, the second magnetic configuration comprises a third magnetic element orientated to have an opposing magnetic polarity to the first magnetic element such that the first and third magnetic elements attract each other.

In an embodiment of any of the above, the first magnetic element is arranged proximal to the third magnetic element when the cover member is in the other of the relatively open position and the relatively closed position.

In an embodiment of any of the above, the second magnetic configuration comprises an intermediate magnetic element, wherein the first magnetic element is orientated to have the same magnetic polarity as the intermediate magnetic element such that the first and intermediate magnetic elements repel each other.

In an embodiment of any of the above, the first magnetic element is arranged proximal to the intermediate magnetic element when the cover member is in an intermediate position between the relatively open position and the relatively closed position.

In an embodiment of any of the above, the intermediate magnetic element is disposed between the second and third magnetic elements.

In an embodiment of any of the above, the second magnetic element, the intermediate magnetic element and the third magnetic element are arranged in series.

In an embodiment of any of the above, the first magnetic configuration consists of a single magnetic element.

In an embodiment of any of the above, the second magnetic configuration consists of two or three magnetic elements.

In an embodiment of any of the above, the second magnetic configuration comprises three magnetic elements arranged on an arcuate path.

In an embodiment of any of the above, the first magnetic element is arranged to travel along the arcuate path responsive to rotation of the actuating member.

In an embodiment of any of the above, the first magnetic configuration is arranged to overlap at least a part of the second magnetic configuration in a radial plane of the aerosol provision device when the cover member is in at least one of the relatively open position, the relatively closed position and an intermediate position between the relatively open position and the relatively closed position.

In an embodiment of any of the above, the first magnetic configuration is arranged to overlap a first part of the second magnetic configuration in a radial plane of the aerosol provision device when the cover member is in the relatively open position.

In an embodiment of any of the above, the first magnetic configuration is arranged to overlap a second part of the second magnetic configuration in a radial plane of the aerosol provision device when the cover member is in the intermediate position.

In an embodiment of any of the above, the first magnetic configuration is arranged to overlap a third part of the second magnetic configuration in a radial plane of the aerosol provision device when the cover member is in the relatively closed position.

In an embodiment of any of the above, the cover mechanism comprises a third magnetic configuration and a fourth magnetic configuration, wherein the third and fourth magnetic configurations are arranged to interact to bias rotation of the actuating member relative to the body.

In an embodiment of any of the above, the third and fourth magnetic configurations are disposed on an opposite side of the opening relative respectively to the first and second magnetic configurations.

In an embodiment of any of the above, the third magnetic configuration is similar to the first magnetic configuration.

In an embodiment of any of the above, the fourth magnetic configuration is similar to the second magnetic configuration.

In an embodiment of any of the above, the third magnetic configuration is in a fixed relationship with the actuating member and the fourth magnetic configuration is in a fixed relationship with the body.

In accordance with embodiments described herein, there is provided an aerosol provision system comprising the aerosol provision device of any of the above and an article comprising aerosol generating material.

### BRIEF DESCRIPTION OF THE DRAWINGS

Embodiments of the invention will now be described, by way of example only, with reference to accompanying drawings, in which:

FIG. 1 shows a schematic front view of an aerosol provision device with a cover assembly;

FIG. 2 shows a schematic cross-sectional side view of the aerosol provision device of FIG. 1;

FIG. 3 shows a schematic perspective view of a cover assembly for the aerosol provision device of FIG. 1 in a closed position with some components shown semi-transparently to show hidden features; and

FIG. 4 shows a schematic perspective view of the cover mechanism of FIG. 3 in an open position with some components shown semi-transparently to show hidden features.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavourants. Aerosol-generating material may include any plant based material, such as tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like.

Aerosol-generating material may for example also be a combination or a blend of materials. Aerosol-generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

An aerosol generating device can receive an article comprising aerosol generating material for heating. An “article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

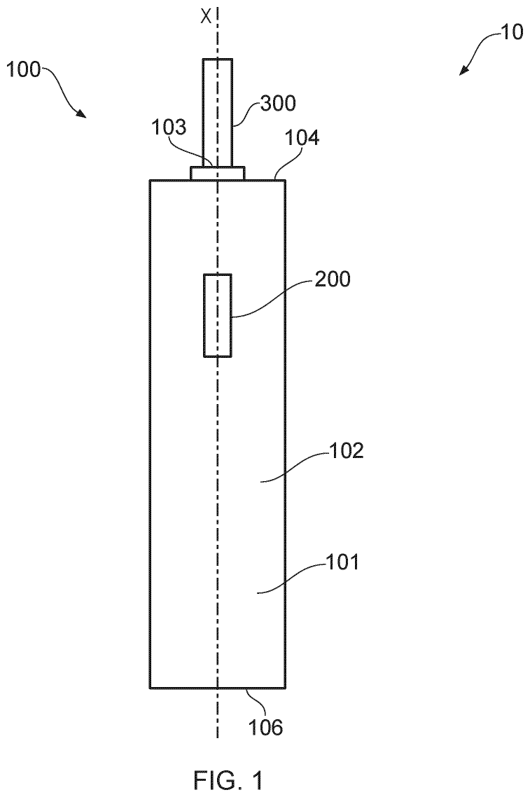

FIG. 1 shows an aerosol provision device 100 for generating aerosol from an aerosol generating material. In broad outline, the device 100 may be used to heat a replaceable article 300 comprising the aerosol generating material, to generate an aerosol or other inhalable medium which is inhaled by a user of the device 100. The article 300 and the device 100 together form an aerosol provision system 10.

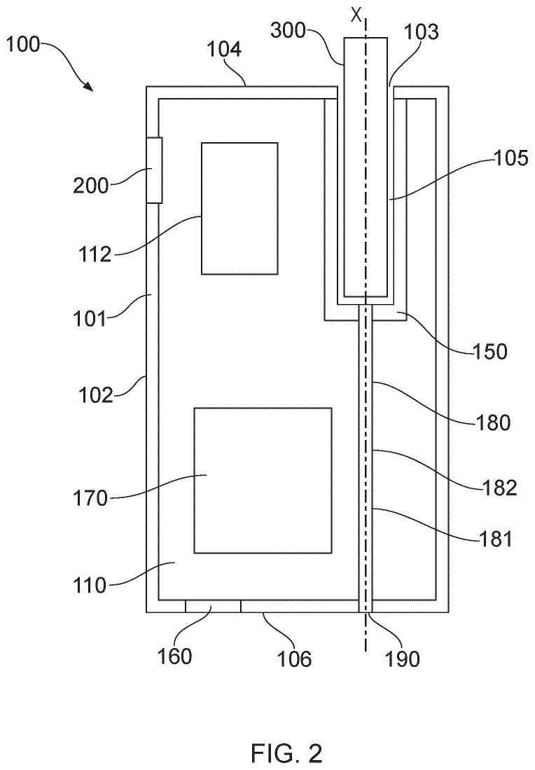

The device 100 comprises a main body 101. The main body 101 comprises a chamber 105, as shown in FIG. 2. The chamber 105 defines a heating zone 107. The heating zone 107 is arranged to at least partially receive the article 300. A housing 102 surrounds and houses various components of the main body 101. An opening 103 is formed at one end of the main body 101, communicating with the chamber 105. The article 300 may be at least partially inserted through the opening 103 into the heating zone 107 for heating by an aerosol generator 150 (refer to FIG. 2). In use, the article 300 may be heated by one or more components of the aerosol generator 150.

The device 100 also includes a button assembly 200, which operates the device 100 when pressed. For example, a user may turn on the device 100 by operating the button assembly 200. The button assembly 200 may be assembled as part of the other assemblies of the aerosol provision device 100.

The aerosol generator 150 defines a longitudinal axis X.

FIG. 2 shows a schematic cross sectional view of the device 100. The device 100 comprises an electrical component, such as a connector/port 160, which can receive a cable to charge the device 100. For example, the connector 160 may be a charging port, such as a USB charging port. In some examples the connector 160 may be used additionally or alternatively to transfer data between the device 100 and another device, such as a computing device.

The device 100 comprises a power source 170, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generator 150 to supply electrical power when required and under control of a controller to heat the aerosol generating material.

The device 100 comprises an electronics module 112. The electronics module 112 may comprise, for example, a printed circuit board (PCB). The PCB may support at least one controller, such as a processor, and memory. The PCB may also comprise one or more electrical tracks to electrically connect together various electronic components of the device 100. For example, the battery terminals may be electrically connected to the PCB so that power can be distributed throughout the device 100.

The main body 101 defines ends of the device 100. The end of the device 100 closest to the opening 103 may be known as the proximal end (or mouth end) 104 of the device 100 because, in use, it is closest to the mouth of the user. In use, a user inserts an article 300 into the opening 103, operates the aerosol generator 150 to begin heating the aerosol generating material and draws on the aerosol generated in the device. This causes the aerosol to flow through the device 100 along a flow path towards the proximal end of the device 100.

The other end of the device furthest away from the aperture 103 may be known as the distal end 106 of the device 100 because, in use, it is the end furthest away from the mouth of the user. As a user draws on the aerosol generated in the device 100, the aerosol flows in a direction towards the proximal end of the device 100. The terms proximal and distal as applied to features of the device 100 will be described by reference to the relative positioning of such features with respect to each other in a proximal-distal direction along the longitudinal axis X.

As used herein, the term one-piece component refers to a component of the device 100 which is not separable into two or more components following assembly of the device 100. Integrally formed relates to two or more features that are formed into a one piece component during a manufacturing stage of the component.

An air flow passage 180 extends through the main body 101. The airflow passage 180 extends to an air inlet 190. Other airflow arrangements are envisaged. For example, airflow may be provided between a receptacle defining the chamber 105 and the article 300.

In one example, the aerosol generator 150 comprises an induction-type heating system, including a magnetic field generator. The magnetic field generator comprises an inductor coil assembly. The aerosol generator 150 comprises a heating element. The heating element is also known as a susceptor.

A susceptor is a material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The device that is configured to generate the varying magnetic field is referred to as a magnetic field generator, herein.

The aerosol generator 150 is an inductive heating assembly and comprises various components to heat the aerosol generating material of the article 300 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The inductor coil assembly includes an inductor coil. In embodiments, the number of inductor coils differs. In embodiments, a two or more inductor coils are used. The inductor coil assembly also comprises a coil support. The coil support is tubular.

The aerosol generator 150 may include other types of heating systems in addition or in alternative. In embodiments, the aerosol generator 150 includes a resistive heating-type heating system.

The heating element is part of a heating assembly. The heating element of this example is hollow and therefore defines at least part of a receptacle within which aerosol generating material is received. For example, the article 300 can be inserted into the heating element. The heating element is tubular, with a circular cross section. The heating element has a generally constant diameter along its axial length.

In embodiments, the heating assembly defines the receptacle and the heating element upstands in the receptacle. The heating element may comprise a pin or blade arranged to penetrate the consumable. In embodiments, the consumable comprises the heating element and the aerosol provision device comprises an inductor coil arranged to inductively heat the heating element in the consumable.

The heating element is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

In other embodiments, the feature acting as the heating element may not be limited to being inductively heated. The feature, acting as a heating element, may be heatable by electrical resistance. The aerosol generator 150 may therefore comprise electrical contacts for electrical connection with the apparatus for electrically activating the heating element by passing a flow of electrical energy through the heating element.

The receptacle and article 300 are dimensioned so that the article 300 is received by the heating element. This helps ensure efficient heating. The article 300 of this example comprises aerosol generating material. The aerosol generating material is positioned within the receptacle. The article 300 may also comprise other components such as at least one of a filter, wrapping materials and a cooling structure.

The air flow passage 180 extends from the receptacle. The air flow passage 180 is at the distal end. The air flow passage 180 extending from the receptacle is defined by a flow path member 182. The heating element 220 and the flow path member 182 forms part of an airflow path arrangement 181.

The flow path member 182 extends between the heating element and the opening 190. The flow path member 182 is tubular. The flow path member 182 defines a bore. The flow path member extends in an axial direction along its length.

A cover assembly 400 is disposed to selectively cover the opening 103 and will be described in more detail below.

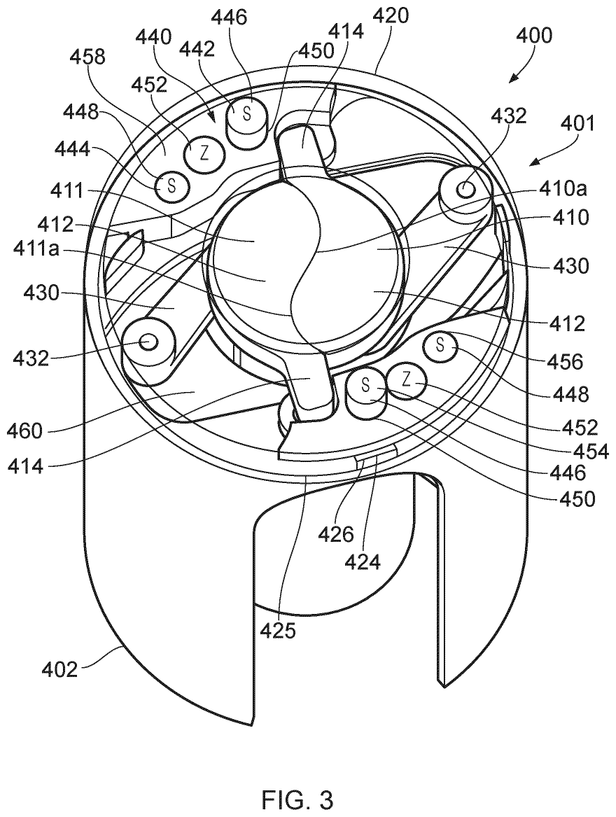

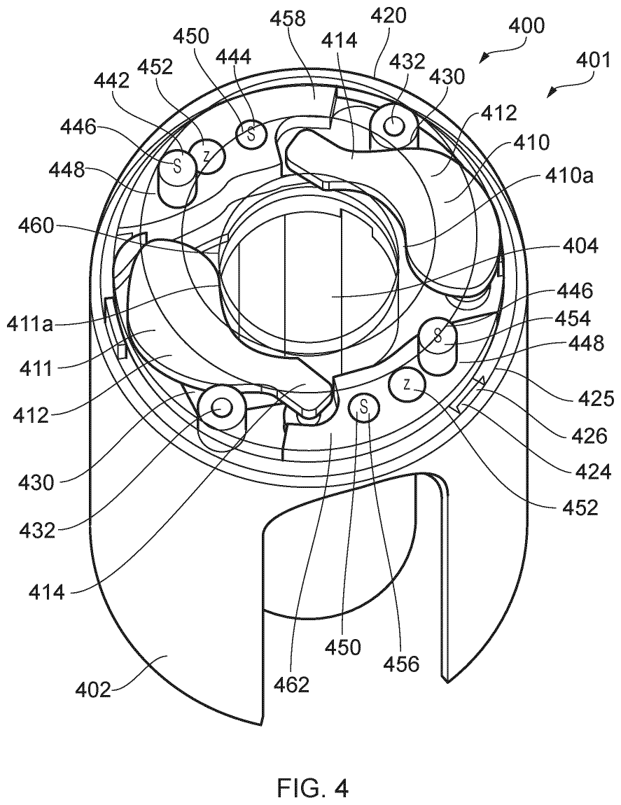

FIG. 3 shows a perspective view of the cover assembly 400 for an aerosol provision device in a closed position and FIG. 4 shows a perspective view of the cover assembly 400 in an open position. Some components are shown transparently to allow for the arrangement of features to be clearly shown and described.

The cover assembly 400 may be used with the aerosol provision device 100 of FIGS. 1 and 2 and will be described by reference to that device. In embodiments, the cover assembly 400 is used with other device arrangements. The cover assembly 400 comprises a cover mechanism 401.

In broad outline, the cover mechanism 401 comprises a body 402, defining the opening 103 of the aerosol provision device, one or more cover members 410, 411 arranged to selectively cover the opening 103 and an actuating member 420. The actuating member 420 is shown in see through in the Figures to clearly show features hidden by the component below. One or more linking members 430 are arranged to move the cover members 410, 411 between a relatively open position in which the at least a portion of an article is able to pass through the opening and a relatively closed position in which the at least a portion of an article is prevented from being able to pass through the opening. The cover members 410, 411 are pivotally attached to the body 402. The actuating member 420 overlies the cover members 410, 411, forming an exterior of the cover mechanism 401. The actuating member 420 is exposed to the exterior of the aerosol provision device 100 and is arranged to be manually actuated by a user.

The cover assembly 400 comprises a body 402. The body 402 is a portion of the main body 101 of the aerosol provision device 100. The body 402 is a rigid member. The body 402 defines part of the housing 102. A seal (not shown) may be provided between the body 402 and other components of the housing 102 of the aerosol provision device 100. The seal may extend around a full peripheral extent of the body 402. In other embodiments, the body 402 may be integrally formed with the housing 102.

The body 402 comprises an opening 404. The opening 404 is the opening 103 of the aerosol provision device 100. The opening 404 communicates with the chamber 105. The opening 404 is dimensioned to receive at least a portion of an article comprising aerosol generating material, such as the article 300.

The cover mechanism 401 of the cover assembly 400 comprises the one or more cover members 410, 411 arranged to selectively cover the opening 404. The cover members 410, 411 co-operate to selectively cover the opening 404. In this embodiment, two cover members 410, 411 are provided. In other embodiments, a different number of cover members may be provided such as one cover member, three cover members, four cover members or substantially any number of cover members.

The cover mechanism 401 comprises a first cover member 410 and a second cover member 411. The first cover member 410 and the second cover member 411 abut one another in the relatively closed position. The first cover member 410 defines a first edge 410a and the second cover member 411 defines a second edge 411a. The first and second edges 410a, 411a are arranged to conform to one another. That is, the first edge 410a and the second edge 411a are profiled to contact one another along their entire length in the relatively closed position. The first edge 410a comprises an arcuate portion and the second edge 411a comprises a corresponding arcuate portion. The first edge 410a is S-shaped and the second edge 411a is correspondingly S-shaped. This provides a particularly space-efficient arrangement of the cover members 410, 411.

In embodiments comprising more than two cover members 410, 411, each cover member may comprise a plurality of edges for abutting adjacent cover members 410, 411.

The cover members 410, 411 are mutually interchangeable. That is, the cover members 410, 411 are identical. In other embodiments, the cover members 410, 411 may differ from one another.

The description will proceed by reference to a single cover member 410, and it will be understood that the other cover member 411 comprises similar or identical features.

The cover member 410 slidably contacts the body 402. The cover member 410 is substantially planar. The cover member 410 comprises a blade portion 412 arranged to at least partially cover the opening 404. In embodiments comprising only a single cover member, the blade portion 412 is arranged to fully cover the opening 404. In embodiments comprising two cover members, each cover member, as shown in FIG. 3, is arranged to cover half of the opening 404, and so together fully cover the opening 404. These proportions may differ.

The cover member 410 comprises an arm portion 414. The arm portion 414 extends from the blade portion 420. The arm portion 414 overlaps the body 402 in both the relatively open position and the relatively closed position. The arm portion 424 may therefore be described as an overlap portion. The blade portion 420 and the arm portion 414 are integrally formed. In other embodiments, the blade portion 420 and the arm portion 414 are separate components in a fixed relationship.

As used herein, the term fixed relationship refers to a relationship in which two components are unable to move relative to one another.

The cover member 410 comprises a lower pivot pin (not shown), acting as a pivot member. The lower pivot pin extends from the arm portion 414. The lower pivot pin 411 is spaced from the blade portion 420. The lower pivot pin is received in a bore in the boy 402. The cover member 410 is therefore pivotally attached to the body 402. In other embodiments, the body 402 may comprise a pin and the cover member 410 may comprise a bore for receiving the pin.

In embodiments, the cover member 410 may comprise an upper pivot pin acting as a pivot member, instead of or in addition to the lower pivot pin. In such embodiments, the body 402 may comprise an upper portion and a lower portion between which the cover member 410 is held. One of the upper and lower pivot pins may be omitted. The upper pivot pin extends from the arm portion 414. The upper pivot pin is spaced from the blade portion 420. The upper pivot pin extends from an opposite side of the arm portion 414 to the lower pivot pin. The upper pivot pin and lower pivot pin are co-axial. The upper pivot pin and lower pivot pin extend parallel to the longitudinal axial direction.

The cover member 410 is a one-piece component. The cover member 410 is integrally formed. In other embodiments, the cover member 410 may be a composite component formed of multiple parts. For example, the upper pivot pin and the lower pivot pin may be a single pin extending through the arm portion 414.

The cover mechanism 401 comprises the actuating member 420. The actuating member 420 is rotatably mounted on the body 402. The actuating member 420 is operable to selectively actuate the cover members 410, 411. The actuating member 420 is exposed to the exterior of the aerosol provision device 100. The actuating member 420 is arranged to be manually operated by a user to actuate the cover members 410, 411.

The actuating member 420 is a substantially annular member. The actuating member 420 defines an aperture 422. The aperture 422 is centrally disposed in the actuating member 420. The aperture 422 may be omitted. The aperture 422 overlies the opening 404 of the body 402. The aperture 422 is axially aligned with the opening 404 of the body 402. The aperture 422 therefore communicates with the heating zone 107.

The actuating member 420 is arranged to rotate on the body 402 to actuate the cover members 410, 411. The actuating member 420 covers part of the body 402.

That is, a portion of the body 402 extends in the actuating member 420. The axis of rotation of the actuating member 420 is parallel with the longitudinal axis of the chamber 105. In embodiments, the axis of rotation is transverse or perpendicular.

The body 402 comprises an actuating member mount 424. The actuating member 420 is rotatably engaged with the actuating member mount 424. The actuating member mount 424 substantially limits movement of the actuating member 420 relative to the body to rotational movement. The actuating member 420 comprises a locating feature 425 in engagement with the actuating member mount 424. The locating feature is a ridge or other suitable feature circumferentially extending around an inner surface of the actuating member 420.

The actuating member mount 424 comprises a clip 426 acting as a retention arrangement. The clip 426 is resilient. The actuating member mount 424 may comprise a plurality of clips 426.

The cover members 410, 411 are disposed between the body 402 and the actuating member 420. The cover members 410, 411 are in sliding contact with the body 402. The cover members 410, 411 are in sliding contact with the actuating member 420. Such an arrangement helps restrict ingress of debris.

Rotation of the actuating member 420 relative to the body 402 causes the cover members 410, 411 to move between a relatively open and a relatively closed position. The linking members 430 link the cover members 410, 411 to the actuating member 430 to enable this movement as described in detail below. The cover assembly 400 is configured to be selectively operated between a relatively open position and a relatively closed position. Such positions are relative to each other. In the relatively open position, at least a portion of the article 300 is able to pass through the opening 404. In the relatively closed position, the at least a portion of the article 300 is prevented from being able to pass through the opening 404.

The term relatively open position will be understood to mean any position in which at least a portion of the article 300 is able to pass through the opening, i.e. including a fully open position and intermediate positions which leave enough space for the portion of the article 300 to be inserted. The term relatively closed position will be understood to mean any position in which the portion of the article 300 is prevented from being able to pass through the opening 404, i.e. including a fully closed position and intermediate positions in which there is not enough space for the article 300 to pass through the opening.

In this embodiment, in the relatively open position, the cover members 410, 411 are free from an overlap with the opening.

In this embodiment, rotation of the actuating member 420 relative to the body 402 causes the cover members 410, 411 to move to or from a fully closed position.

The term fully closed position will be understood to mean that the cover members 410, 411 fully closes the opening 404. The terms open and closed as applied to features of the cover mechanism 401 are herein described in relation to one another.

The cover members 410, 411 are arranged to pivot relative to the body 402. The cover members 410, 411 are arranged to pivot in a direction perpendicular to an axis of rotation of the actuating member 420. The axis of rotation of the actuating member 420 is parallel with a longitudinal axis of the chamber. Movement of the cover members 410, 411 between the relatively open position and the relatively closed position is therefore a rotation of the cover members 410, 411. In other embodiments, such movement may additionally or alternatively comprise translation, that is, linear movement.

The cover mechanism 401 comprises the plurality of linking members 430. The linking members 430 link the cover members 410, 411 to the actuating member 420. The linking members 430 provide a mechanical linkage between the cover members 410, 411 and the actuating member 420. In this embodiment, the cover mechanism 401 comprises one linking member 430 for each cover member 410, 411. That is, the cover mechanism 401 comprises two linking members 430. In other embodiments, the ratio of linking member 430 to cover members 410, 411 may be different. For example, two linking members may be provided for each cover member 410, 411.

The linking members 430 are identical. In other embodiments, the linking members 430 may differ from one another. The description will proceed by reference to a single linking member 430, but it will be understood that the other linking member 430 comprises similar or identical features.

The linking member 430 is pivotally attached to the actuating member 420. The linking member 430 pivots about a fixed point on the actuating member 420. In embodiments, the linking member 430 comprises a pin 432 which is received in a bore in the actuating member 420. In other embodiments, the actuating member 420 comprises a pin which is received in a bore in the linking member 430. In other embodiments, both the linking member 430 and the actuating member 420 comprise bores and a separate pin is provided received in both bores.

The linking member 430 is pivotally attached to the cover member 410. The linking member 430 is pivotally attached to an underside of the cover member 410.

The linking member 430 pivots about a fixed point on the cover member 410. In embodiments, the linking member 430 comprises a pin (not shown) which is received in a bore in the cover member 410. In other embodiments, the cover member 410 comprises a pin which is received in a bore in the linking member 430. In other embodiments, both the linking member 430 and the cover member 410 comprise bores and a separate pin is provided received in both bores.

The linking member 430 is free from linear translation relative to the cover member 410. The linking member 430 is free from linear translation relative to the actuating member 420. That is, the linking member 430 is constrained to only rotate relative to each of the actuating member 420 and the cover member 410.

The linking member 430 is an elongate member. The linking member 430 defines a first end and a second end. The linking member 430 is pivotally attached to the actuating member 420 proximal to the first end. The linking member 430 is pivotally attached to the cover member 410 proximal to the second end.

The linking member 430 is a rod. The linking member 430 is formed of a plastics material. The linking member 430 is formed of polyether ether ketone (PEEK). The linking member 430 is a one-piece component. The linking member 430 is integrally formed.

The linking member 430 is a rigid member. This enables the linking member 430 to push the cover member 410 as well as pull the cover member 410. This enables the linking member 430 selectively to cause movement of the cover member 410 in both a first direction and a second direction.

The linking member 430 is pivotally attached to the blade portion 412 of the cover member 410. The cover member 410 defines a first end and a second end. The linking member 430 is pivotally attached to the cover member 410 proximal to the first end and the cover member 410 is pivotally attached to the body 402 proximal to the second end.

The linking member 430 is pivotally attached to the cover member 410 at a point proximal to the point of attachment of the cover member 410 to the body 402.

This provides a relationship whereby movement of the linking member 430 produces larger movement of the blade portion of the cover member 410. This reduces the range of motion required of the actuating member and provides a spatially efficient arrangement.

Rotation of the actuating member 420 relative to the body 402 causes the movement of the cover members 410, 411 via the linking members 430. As the actuating member 420 is rotated by the user, the linking members 430 cause the cover members 410, 411 to move between the relatively open position and the relatively closed position.

FIG. 3 shows the cover mechanism 401 in a closed position and FIG. 4 shows the cover mechanism 401 in an open position. The cover members 410, 411 are movable between the closed position as shown in FIG. 3 and the open position as shown in FIG. 4. Rotating the actuating member 420 clockwise, as shown in the Figures, causes the cover members 410, 411 to move towards the closed position. Rotating the actuating member 420 counter clockwise, as shown in the Figures, causes the cover members 410, 411 to move towards the open position. In other embodiments, these directions may be reversed. In embodiments, the cover mechanism 401 comprises a lubricant.

The cover mechanism 401 comprises a magnetic biasing arrangement 440. The magnetic biasing arrangement 440 is configured to bias the cover members 410, 411 towards at least one of the relatively open position and the relatively closed position. It will be understood that the magnetic biasing arrangement may be used in a cover mechanism comprising any number of cover members, such as a single cover member or three or more cover members. Although described above with respect to biasing in a rotational manner, it will be understood that the magnetic biasing arrangement 440 may be used with other cover mechanism arrangements, such as a translational movement. Linear biasing may be provided, as well as non-linear biasing movements.

The magnetic biasing arrangement 440 comprises a first magnetic configuration 442. The first magnetic configuration 442 is in a fixed relationship with the actuating member 420. In this embodiment, the first magnetic configuration 442 is joined to the actuating member 420. The first magnetic configuration 442 is at least partially embedded in the actuating member 420.

The magnetic biasing arrangement 440 comprises a second magnetic configuration 444. The second magnetic configuration 444 is in a fixed relationship with the body 402. In this embodiment, the second magnetic configuration is joined to the body 402. The second magnetic configuration 442 is at least partially embedded in the body 402.

Rotation of the actuating member 420 causes relative movement between the first and second magnetic configurations 442, 444. The first and second magnetic configurations 442, 444 are arranged to interact to bias rotation of the actuating member 420 relative to the body 402. The first magnetic configuration 442 and the second magnetic configuration 444 are arranged to attract one another in the relatively open position and in the relatively closed position. The magnitude and direction of the magnetic force generated between the first and second magnetic configurations 442, 444 depends on their positioning relative to one another.

The first magnetic configuration 442 and the second magnetic configuration 444 are arranged to repel one another in an intermediate position between the relatively open position and the relatively closed position. The magnetic biasing arrangement 440 is configured to bias the cover members 410, 411 away from the intermediate position. The intermediate position is half way between the relatively open position and the relatively closed position. In embodiments, the location of the intermediate position may differ, for example the intermediate position may be one third of the way between the relatively open position and the relatively closed position.

The magnetic biasing arrangement 440 is configured to bias the cover members 410, 411 towards the relatively open position over a first range of motion adjacent to the relatively open position and the magnetic biasing arrangement 440 is configured to bias the cover members 410, 411 towards the relatively closed position over a second range of motion adjacent to the relatively closed position.

The intermediate position provides the divide between the first range of motion and the second range of motion. As the actuating member 420 is rotated to cause the cover members 410, 411 to move out of the relatively open position, the cover members 410, 411 are urged back towards the relatively open position and away from the intermediate position. If the user applies sufficient force to overcome the urging, and the cover members 410, 411 pass the intermediate position, they are then urged towards the relatively closed position and away from the intermediate position. The same applies in reverse.

The cover mechanism 401 returns to the relatively open position or the relatively closed position in the absence of external forces strong enough to overcome the magnetic forces exerted by the magnetic biasing arrangement 440. This provides an improved user experience, as the user does not need to rotate the actuating member 420 through the full range of motion to cause the cover members 410, 411 to enter the relatively closed or open positions. The cover members 410, 411 are therefore less likely to remain in an intermediate position (including the above-mentioned intermediate position or substantially any position between the relatively open and closed positions), which could lead to blockage or inconvenience.

The first magnetic configuration 442 comprises a first magnetic element 446. In this embodiment, the first magnetic configuration 442 consists of a single magnetic element 446, though in embodiments, the first magnetic configuration 442 may comprise further magnetic elements.

The second magnetic configuration 444 comprises a second magnetic element 448. The first magnetic element 446 is orientated to have an opposing magnetic polarity to the second magnetic element 448 such that the first and second magnetic elements 446, 448 attract each other. The first magnetic element 446 is arranged proximal to the second magnetic element 448 when the cover members 410 are in the relatively open position. The first magnetic element 446 is arranged directly above the second magnetic element 448 parallel to the axial direction X when the cover members 410, 411 are in the relatively open position, though in embodiments this may differ.

The second magnetic element 448 is disposed at or proximal to an end of the range of motion of the first magnetic element 446. This allows the second magnetic element 448 to pull the first magnetic element 446 fully to the end of its range of motion. This may reduce instability or rattling in the cover mechanism 401.

The second magnetic configuration 444 comprises a third magnetic element 450. The third magnetic element is orientated to have an opposing magnetic polarity to the first magnetic element 446 such that the first and third magnetic elements 446, 450 attract each other. The first magnetic element 446 is arranged proximal to the third magnetic element 450 when the cover members 410, 411 are in the relatively closed position. The first magnetic element 446 is arranged directly above the third magnetic element 450 parallel to the axial direction X when the cover members 410, 411 are in the relatively open position, though in embodiments this may differ.

The third magnetic element 450 is disposed at or proximal to an end of the range of motion of the first magnetic element 446. This allows the third magnetic element 450 to pull the first magnetic element 446 fully to the end of its range of motion. This may reduce instability or rattling in the cover mechanism 401.

The second magnetic configuration 444 comprises an intermediate magnetic element 452. In this embodiment, the second magnetic configuration therefore consists of three magnetic elements. In embodiments, the second magnetic configuration may consist of a greater or lesser number of magnetic elements. For example, the intermediate magnetic element may be omitted or further intermediate or other magnetic elements may be provided.

In embodiments, the second and third magnetic elements 448, 450 may be omitted. In embodiments, the second magnetic configuration 444 may consist only of intermediate magnetic elements. That is, rather than utilising attractive forces between the magnetic configurations 442, 444, the magnetic biasing arrangement 440 may rely solely on repulsive forces between the magnetic configurations 442, 444 to push rather than pull the first magnetic configuration 442. Such an embodiment may permit simpler manufacture, lighter weight and lower component cost.

In embodiments in which the intermediate magnetic element 452 is omitted, the cover mechanism 401 may be unbiased or only weakly biased over part of its range of motion. In embodiments, the cover mechanism 401 may be biased over its entire range of motion. This reduces the change of the cover mechanism 401 becoming stuck and increases user convenience. Embodiments in which the intermediate magnetic element 452 is omitted may further provide lower mechanical stresses within the cover mechanism 401, because the first magnetic element 446 does not travel over a repulsive intermediate magnetic element 452. This may improve the reliability and lifespan of the cover mechanism 401.

The first magnetic element 446 is orientated to have the same magnetic polarity as the intermediate magnetic element 452 such that the first and intermediate magnetic elements 446, 452 repel each other. The first magnetic element 446 is arranged proximal to the intermediate magnetic element 452 when the cover members 410, 411 are in the intermediate position. The first magnetic element 446 is arranged directly above the intermediate magnetic element 452 parallel to the axial direction X when the cover members 410, 411 are in the relatively open position, though in embodiments this may differ.

The intermediate magnetic element 452 is disposed between the second and third magnetic elements 448, 450. The second magnetic element 448, the intermediate magnetic element 452 and the third magnetic element 454 are arranged in series. The second magnetic element 448, the intermediate magnetic element 452 and the third magnetic element 454 are arranged on a circular path. The first magnetic element 446 is arranged to travel along the circular path responsive to rotation of the actuating member.

In overview, the second magnetic configuration 444 comprises a plurality of magnetic elements 446, 448, 450 arranged along a path of travel of the first magnetic configuration 442. The first magnetic configuration 442 is smaller than the second magnetic configuration 444 and overlaps a part of the second magnetic configuration 444 over its entire range of motion. In embodiments, part or all of the range of motion of the first magnetic configuration may be free from an overlap with the second magnetic configuration.

This arrangement allows a biasing force to be exerted between the first magnetic configuration 442 and the second magnetic configuration 444 through the entire range of motion of the cover mechanism 401. This allows efficient operation of the magnetic forces, as their direction may be parallel or tangential to the path of the first magnetic configuration 442 throughout the entire range of motion. This reduces mechanical stresses in the cover mechanism 401 and provides improved stability and control to the movement of the cover mechanism 401. This arrangement also allows the strength of the biasing force to be relatively consistent over the range of motion of the cover mechanism 401 compared to embodiments in which fewer magnetic elements are provided, by limiting the maximum distance between the first magnetic element 446 and any other magnetic element at any position along the range of motion.

The second magnetic configuration 444 and the first magnetic configuration 442 are spaced from one another in the axial direction X of the aerosol provision device 100. A clearance is provided between the first magnetic configuration 442 and the second magnetic configuration 444. The clearance is less than 3 mm, less than 2 mm, less than 1 mm or less than 0.5 mm. The clearance is greater than 0.01 mm.

The clearance is selected to minimise ingress of debris between the magnetic configurations 442, 444 and to minimise the risk of jamming or wear between them. In embodiments, further components may be provided between the first and second magnetic configurations 442, 444.

The first magnetic configuration 442 is arranged to overlap at least a part of the second magnetic configuration 444 in a radial plane of the aerosol provision device 100 when the cover members 410, 411 are in the relatively open position, the relatively closed position and an intermediate position between the relatively open position and the relatively closed position.

The first magnetic configuration 442 is arranged to overlap a first part of the second magnetic configuration 444 in the radial plane of the aerosol provision device 100 when the cover members 410, 411 are in the relatively open position. The first part of the second magnetic configuration 444 comprises the first magnetic element 446.

The first magnetic configuration 442 is arranged to overlap a second part of the second magnetic configuration 444 in the radial plane of the aerosol provision device 100 when the cover members 410, 411 are in the intermediate position. The second part of the second magnetic configuration 444 comprises the intermediate magnetic element 452.

The first magnetic configuration 442 is arranged to overlap a third part of the second magnetic configuration 444 in the radial plane of the aerosol provision device 100 when the cover members 410, 411 are in the relatively closed position. The third part of the second magnetic configuration comprises the third magnetic element 450.

The magnetic biasing arrangement 440 comprises a third magnetic configuration 454. The third magnetic configuration 454 is in a fixed relationship with the actuating member 420. In this embodiment, the third magnetic configuration 454 is joined to the actuating member 420. The third magnetic configuration 454 is at least partially embedded in the actuating member 420.

The magnetic biasing arrangement 440 comprises a fourth magnetic configuration 456. The fourth magnetic configuration 456 is in a fixed relationship with the body 402. In this embodiment, the fourth magnetic configuration 456 is joined to the body 402. The fourth magnetic configuration 456 is at least partially embedded in the body 402.

The third and fourth magnetic configurations 454, 456 comprise similar or identical features to the first and second magnetic configurations 442, 444 respectively. The same reference numerals are used for the features of the third and fourth magnetic configurations 454, 456 as are used for the features of the first and second magnetic configurations 442, 444. The third and fourth magnetic configurations 454, 456 are arranged to interact to bias rotation of the actuating member 420 relative to the body 402.

The third and fourth magnetic configurations 454, 456 are disposed on an opposite side of the opening 404 relative respectively to the first and second magnetic configurations 442, 444. This provides a symmetrical design which minimises internal stresses in the cover mechanism 401, and improves the stability and control of the cover mechanism 401.

In embodiments, further magnetic configurations may be provided to further improve the stability of motion of the cover mechanism 401. In such embodiments, the further magnetic configurations may be provided in pairs of magnetic configurations similar or identical to the first and second magnetic configurations 442, 444.

Embodiments consisting only of the first and second magnetic configurations 442, 444, that is, omitting the third and fourth magnetic configurations 454, 456 or other magnetic configurations, may provide lower complexity, more convenient manufacture and lower component cost.

Embodiments consisting only of the first, second, third and fourth magnetic configurations 442, 444, 454, 456, that is, omitting further magnetic configurations, may provide lower mechanical stresses within the cover mechanism 401. This arrangement provides an advantageous balance between symmetry and minimising magnetic forces in the axial direction X of the aerosol provision device 100, which may lead to mechanical stress within the cover mechanism 401 resulting in increased wear and decreased lifespan and reliability of the cover mechanism 401.

In embodiments, the first and second magnetic configurations 442, 444 may be reversed. That is, the first magnetic configuration 442 may be in a fixed relationship with the body 402 and the second magnetic configuration 444 may be in a fixed relationship with the actuating member 420.

The body 402 comprises a raised portion 458. The raised portion 458 is raised relative to a recess 460 of the body 402. The raised portion 458 accommodates the second magnetic configuration 444. The second magnetic configuration 444 is embedded in the raised portion 458. The recess 460 accommodates the cover members 410, 411 and the linking members 430. In embodiments comprising the third and fourth magnetic configurations 454, 457, the raised portion 458 may be a first raised portion and the body 402 may comprise a second raised portion 462. The second raised portion 462 may be similar or identical to the first raised portion 458. The second raised portion 462 accommodates the fourth magnetic configuration 456. The second raised portion 462 may be joined to the first raised portion 458 or separated from the first raised portion 458. That is, the first and second raised portions 458, 462 may be portions of a single continuous raised portion. The recess 460 is defined between the first raised portion 458 and the second raised portion 462.

The opening 404 is provided in the recess 460. Such an arrangement may assist in confining debris to the region of the opening 404 and reducing ingress of debris into the cover mechanism 401.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device for generating aerosol from an aerosol generating material, the aerosol provision device comprising:
a body defining an opening;
a heating zone arranged to receive at least a portion of an article comprising aerosol generating material inserted through the opening; and
a cover mechanism comprising:
a cover member arranged to selectively at least partially cover the opening;
an actuating member arranged to rotate on the body to actuate the cover member, wherein rotation of the actuating member relative to the body causes the cover member to move between a relatively open position in which the at least a portion of an article is able to pass through the opening and a relatively closed position in which the at least a portion of an article is prevented from being able to pass through the opening; and
a magnetic biasing arrangement configured to bias the cover member towards at least one of the relatively open position and the relatively closed position.

2. The aerosol provision device of claim 1, wherein the magnetic biasing arrangement is configured to bias the cover member away from an intermediate position between the relatively open position and the relatively closed position.

3. The aerosol provision device of claim 1, wherein the magnetic biasing arrangement is configured to bias the cover member towards the relatively open position over a first range of motion adjacent to the relatively open position and the magnetic biasing arrangement is configured to bias the cover member towards the relatively closed position over a second range of motion adjacent to the relatively closed position.

4. The aerosol provision device of claim 1, wherein the magnetic biasing arrangement comprises a first magnetic configuration and a second magnetic configuration, wherein the first magnetic configuration and the second magnetic configuration are arranged to interact to bias rotation of the actuating member relative to the body.

5. The aerosol provision device of claim 4, wherein rotation of the actuating member causes relative movement between the first magnetic configuration and the second magnetic configuration.

6. The aerosol provision device of claim 4, wherein the first magnetic configuration is in a fixed relationship with the actuating member and the second magnetic configuration is in a fixed relationship with the body.

7. The aerosol provision device of claim 4, wherein the first magnetic configuration comprises a first magnetic element and the second magnetic configuration comprises a second magnetic element, wherein the first magnetic element is orientated to have an opposing magnetic polarity to the second magnetic element such that the first and second magnetic elements attract each other.

8. The aerosol provision device of claim 7, wherein the first magnetic element is arranged proximal to the second magnetic element when the cover member is in at least one of one of the relatively open position and the relatively closed position.

9. The aerosol provision device of claim 7, wherein the second magnetic configuration comprises a third magnetic element orientated to have an opposing magnetic polarity to the first magnetic element such that the first and third magnetic elements attract each other.

10. The aerosol provision device of claim 9, wherein the first magnetic element is arranged proximal to the third magnetic element when the cover member is in the other of the relatively open position and the relatively closed position.

11. The aerosol provision device of claim 7, wherein the second magnetic configuration comprises an intermediate magnetic element, wherein the first magnetic element is orientated to have the same magnetic polarity as the intermediate magnetic element such that the first and intermediate magnetic elements repel each other.

12. The aerosol provision device of claim 11, wherein the first magnetic element is arranged proximal to the intermediate magnetic element when the cover member is in an intermediate position between the relatively open position and the relatively closed position.

13. The aerosol provision device of claim 11, wherein the intermediate magnetic element is disposed between the second and third magnetic elements.

14. The aerosol provision device of claim 4, wherein the first magnetic configuration consists of a single magnetic element.

15. The aerosol provision device of claim 4, wherein the second magnetic configuration comprises three magnetic elements arranged on a circular path.

16. The aerosol provision device of claim 4, wherein the first magnetic configuration is arranged to overlap at least a part of the second magnetic configuration in a radial plane of the aerosol provision device when the cover member is in at least one of the relatively open position, the relatively closed position and an intermediate position between the relatively open position and the relatively closed position.

17. The aerosol provision device of claim 4, wherein the first magnetic configuration is arranged to overlap a first part of the second magnetic configuration in a radial plane of the aerosol provision device when the cover member is in the relatively open position.

18. The aerosol provision device of claim 4, wherein the first magnetic configuration is arranged to overlap a second part of the second magnetic configuration in a radial plane of the aerosol provision device when the cover member is in the intermediate position.

19. The aerosol provision device of claim 4, wherein the first magnetic configuration is arranged to overlap a third part of the second magnetic configuration in a radial plane of the aerosol provision device when the cover member is in the relatively closed position.

20. (canceled)

21. (canceled)

22. (canceled)

23. An aerosol provision system comprising the aerosol provision device of claim 1, and an article comprising aerosol generating material.
